(19) United States
(12) Patent Application Publication
(10) Pub. No.: US 2026/0328156 A1
(43) Pub. Date: Oct. 22, 2026

(54) METHOD OF CONTROLLING A HYDROGEN INTERNAL COMBUSTION ENGINE

(71) Applicant: PHINIA DELPHI LUXEMBOURG SARL, Belvaux (LU)

(72) Inventors: Damien BARALON, Meung sur Loire (FR); Mathieu DA GRACA, Chaumont sur Loire (FR)

(21) Appl. No.: 19/113,092

(22) PCT Filed: Sep. 15, 2023
(86) PCT No.: PCT/EP2023/075452

§ 371 Date: Mar. 19, 2025

(30) Foreign Application Priority Data
Sep. 20, 2022 (GB) 2213718.6

(51) Int. Cl. F02D 41/38

(52) U.S. Cl. CPC F02D 41/38; F02D 2200/04; F02D 2200/101

(57) ABSTRACT

A method of operating a hydrogen internal combustion engine, in which combustion events are operated by injecting a predetermined fuel quantity Q_{F} in at least one cylinder, includes the steps of determining a fuel demand Q_{D} from an input torque demand T_{D}; determining a corresponding desired air mass M_{D} based on the fuel demand Q_{D} and on a standard lambda number L_{STD}, and adjusting at least one charge air parameter based on the desired air mass M_{D}; and determining the predetermined fuel quantity Q_{F} based on current (intake) air flow M_{F} rate and on a lambda setpoint L_{SET} corresponding to the standard lambda number L_{STD}. In case of a variation in torque demand, the lambda setpoint L_{SET} is set to a lambda value referred to as fast lambda L_{FAST}. L_{FAST} is a lambda number computed based on the current air flow rate M_{F} and current fuel demand Q_{D}.

### FIELD OF THE INVENTION

The present invention generally relates to spark-ignited internal combustion engines and more specifically to combustion control in a hydrogen engine.

### BACKGROUND OF THE INVENTION

For automotive applications, hydrogen engines are considered as a promising alternative to gasoline or diesel engines since the emissions from a hydrogen engine consist mainly of water.

Today, hydrogen fueled engines are developed/designed based mainly on the knowledge and know-how gained with gasoline engines, making required adaptations and new developments.

As is known, gasoline/gas operated engines are controlled based on an ‘air lead’ approach, where lambda is mainly constant (stoichiometric), the air charge being adjusted in function of load and then the fuel being computed from the fresh air flow to meet the lambda setpoint. This control of the air fuel mixture is required for optimal operation of the catalytic converter.

One drawback of this conventional approach, when applied to hydrogen combustion engines, is a lag in torque response, when the driver depresses the accelerator pedal to request a rapid change of torque. This lag is due to a combination of elements: boost lag from the turbocharger running with low enthalpy (lean lambda setpoint); lambda demand depends on actual torque to get consistent combustion setpoints (Air/spark/injection timing demand).

### OBJECT OF THE INVENTION

The object of the present invention is to provide a method of operating a hydrogen combustion engine, which alleviates the above shortcomings.

This object is achieved by a method of operating a hydrogen internal combustion engine as claimed in claim 1.

### SUMMARY OF THE INVENTION

The present invention relates to a method of operating a hydrogen internal combustion engine, wherein combustion events are operated by injecting a predetermined fuel quantity Q_{F} in at least one cylinder. Typically, this fuel quantity is determined for one engine cycle (i.e. for all cylinders) and the fuel amount Q_{F} is then distributed between the various engine cylinders for the corresponding cycle. Hence Q_{F}, or more precisely the fraction thereof for a corresponding cylinder, is the value of fuel amount based on which the fuel injector command (Pulse width) is based. That is, the fuel injectors are controlled so that, over the engine cycle, a fuel amount corresponding to Q_{F} is injected in the engine.

In operation, a fuel demand Q_{D} is determined from an input torque demand T_{D}, and a corresponding desired air mass M_{D} is determined based on the fuel demand Q_{D} and on a predetermined lambda setpoint corresponding to a lean, standard lambda L_{STD}. At least one charge air parameter is subsequently adjusted based on said desired air mass M_{D}. The term “charge air parameter” herein refers to a parameter that effects the amount of air entering the engine. For example, adjusting at least one charge air parameter may involve adjusting at least one of a throttle position and a variable gate of a turbocharger. The torque demand T_{D} represents the sum of torque demands comprised of driver torque demand (direct via accelerator pedal or indirect via cruise control, e.g.) and torque demands of other engine/vehicle components).

Standard lambda L_{STD} is a predetermined value that is conventionally set for a lean air to fuel ratio in stabilized or quasi-stabilized running condition. In the case of a hydrogen engine, the standard lambda L_{STD} number may generally lie between 1.8 and 3.

According to the invention, in case of a variation in torque demand T_{D}, the lambda setpoint L_{SET} is set to a lambda value referred to as fast lambda L_{FAST}. Fast lambda L_{FAST} is a lambda number computed based on the current air flow rate M_{F} and current fuel demand Q_{D}.

Hence, in the present method, in case a variation in torque demand is detected, a fast lambda strategy is applied, which uses a lambda L_{FAST} as setpoint (L_{SET}) which deviates from the standard lambda (L_{STD}) determined for steady state.

For example, in case of a strong torque demand, a richer lambda value is used as setpoint for the calculation of fuel quantity Q_{F}, which deviates from the standard lambda calibrated for efficient and low NOx combustion.

The fast lambda permits deviating from a strict “air lead” approach and allows fuel change rate at a different rate than “air” change rate during torque transient operations. This will reduce the time required to meet the power demand.

It should be noted that the present method significantly differs from conventional practice with gasoline engines, where lambda is essentially constant, the charge air being adjusted in function of load and the fuel being computed from the actual air flow rate to respect strictly the lambda setpoint. Conventional gasoline engine control is not designed to adapt to a range of lambda numbers, as permitted with hydrogen.

By contrast, the present method is applicable because the fuel is hydrogen: hydrogen engines has a precise combustion lambda authority which allows to run in a finite range of lambda values. For example, hydrogen engines may be operated with lambda values (standard lambda) in the range of 1.8 to 3.

The term lambda (or lambda number) is used herein to represent the air-fuel ratio actually present in a combustion chamber compared to the stoichiometric air-fuel ratio. Conventionally, a lambda number of 1.0 corresponds to the stoichiometric combustion conditions. The term lambda should be generally construed to include any parameter representative of the stoichiometry of the combustion, with different scales or indicators.

In the context of the invention, the term “variation in torque demand” refers to an increase or decrease of torque demand, leading to a torque transient, that can be determined by any appropriate approach. For example, a variation in torque demanded can be determined by comparing a torque difference (Torque(t1)−Torque(t0)) to a threshold, or by comparing a torque ratio (rate of change in torque: Torque(t1)/Torque(t0)) to a threshold. Hence, a variation in torque demand may be considered to be present where the difference in torque between the current timepoint and a previous time point (determined as a difference or a ratio) exceeds a predefined threshold.

In particular, the rate of variation of torque demand can be determined by comparing the current Torque demand to a reference torque demand. The reference torque demand can be a previous torque value. Alternatively, the reference torque demand can be a moving average of previous torque values.

In embodiments, the fast lambda L_{FAST} is capped by a limit representing a relative lambda ratio R_{DEV} of L_{FAST} with respect to the standard lambda value L_{STD}.

In embodiments, R_{DEV} is calibrated and dependent on the difference in torque demand. That is the difference in torque demand can be input in a map, which gives a corresponding value of R_{DEV}. The difference in torque demand can be determined as a difference between current and reference torque values, as explained above (in particular where the reference is a moving average).

In doing so, L_{FAST} can be computed permanently, the R_{DEV} map can be used permanently and applied as L_{SET}. Where the torque difference is no deviation from standard lamba values is desired, then R_{DEV} is set to 0, whereby do deviation from L_{STD} is allowed, and hence L_{FAST} is set to a standard L_{SET} value. However where a greater torque difference exists, mapped R_{DEV} values allow a certain deviation from L_{STD} to reduce lag effects.

For example, the relative lambda ratio R_{DEV} may vary between −30% and +30%. Hence allowing +/−30% variation from L_{STD}.

In embodiments, L_{FAST} is further capped between a minimum lambda value Lₘᵢₙ and a maximum lambda value Lₘₐₓ that are calibrated in function of engine speed and engine load. For example, Lₘᵢₙ may be in the range of about 1.5 to 1.8; and Lₘₐₓ may lie in the range of about 2.2 to 3.5.

In embodiments, the fuel demand Q_{D}, respectively the fuel quantity Q_{F}, are determined for an engine cycle (The quantity to be injected in all of the cylinders).

In embodiments, the lambda setpoint L_{SET} is set (back) to standard lambda values (i.e. values corresponding to steady state) when the difference in torque is low (quasi-zero) or zero.

### BRIEF DESCRIPTION OF THE DRAWINGS

The present invention will now be described, by way of example, with reference to the accompanying drawings, in which:

FIG. 1: is a principle diagram illustrating a prior art engine management strategy;

FIG. 2: is a principle diagram illustrating an embodiment of the present method of operating an engine;

FIGS. 3 and 4: are plots illustrating the response to a load step with a prior art engine management strategy corresponding to FIG. 1;

FIGS. 5 and 6: are plots illustrating the response to a load step implementing the inventive strategy of FIG. 2.

### DETAILED DESCRIPTION OF PREFERRED EMBODIMENTS

As is known, in a gasoline engine a throttle valve controls the rate of air supplied to the engine in response to a power demand by the vehicle operator such that a fuel supply system supplies an amount of fuel based on the air supply rate to obtain a desired air/fuel ratio.

To reduce the exhaust emissions, the engine is typically equipped with a catalytic converter having the functionality of a reduction catalyst to reduce NO₂ to nitrogen and oxygen and an oxidation catalyst to oxidize CO to CO₂ and HC to water and CO₂.

For optimum operation of the catalytic converter, the spark ignition engine is operated under stoichiometric operating conditions in which the amount of oxygen supplied to the cylinders of the engine is the exact amount required to completely combust the amount of fuel supplied. In the case of gasoline the stoichiometric air/fuel ratio is around 14.7:1, although the exact value depends on the fuel composition.

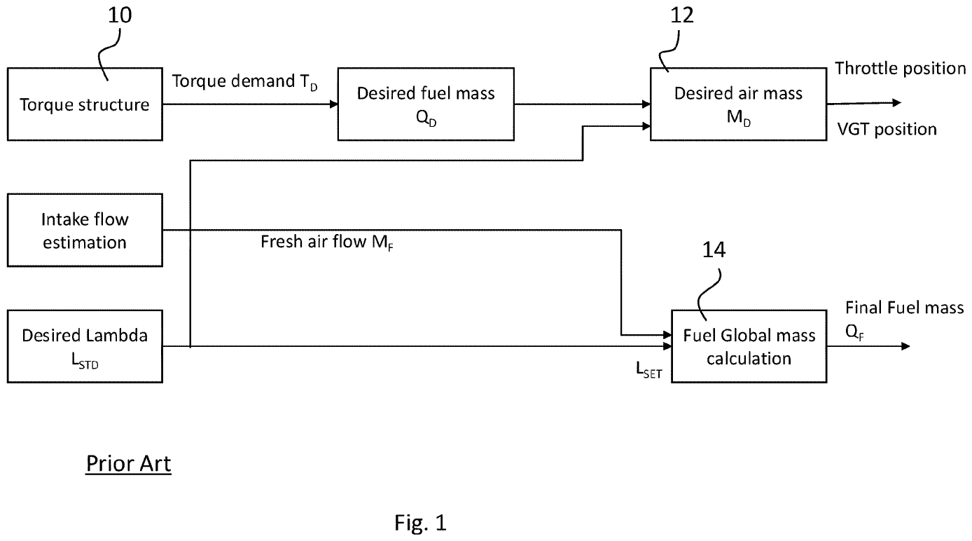

A conventional air-lead combustion management strategy of such gasoline combustion engine is illustrated in FIG. 1. Reference sign 10 designates a torque structure module that receives torque demands from various components, for example direct torque demand from the driver (accelerator pedal) or indirect torque demand via cruise control, torque demands from the transmission system, from driving dynamics, or torque demands related to specific components (catalytic converter, HVAC, etc.). The torque structure module 10 coordinates these various demands and generates a global torque demand T_{D}.

A desired fuel mass Q_{D} (also referred to as fuel demand) is then determined to meet the desired torque demand T_{D}, typically by calculation based on IMEP (Indicated Mean Effective Pressure), cylinder volume and combustion efficiency coefficients. At 12 a desired air mass M_{D} is computed based on the desired fuel mass Q_{D} and taking into account a desired Lambda number L_{STD}. The throttle and turbocharger gate positions are adjusted on the basis of the desired air mass. The Lambda number is set for a stoichiometric combustion.

The fuel calculation module 14 determines a final fuel mass Q_{F}, i.e. the fuel quantity to be injected into the engine for the upcoming combustion cycle (total fuel for all cylinders) and used in the engine management scheme. The final fuel mass Q_{F} is determined on the basis of the fresh air flow M_{F} and for a given lambda setpoint L_{SET}. For the benefit of the catalytic converter, the lambda setpoint is chosen to obtain a stoichiometric combustion, i.e. L_{SET}=L_{STD}=1.0.

As indicated previously, combustion management strategies as shown in FIG. 1 are now the basis for controlling hydrogen engines. When operating a hydrogen engine with the above scheme, the standard lambda number is typically calibrated for lean combustion, to avoid Nox production. The standard lean Lambda may be around L_{STD}=2.7.

### Invention

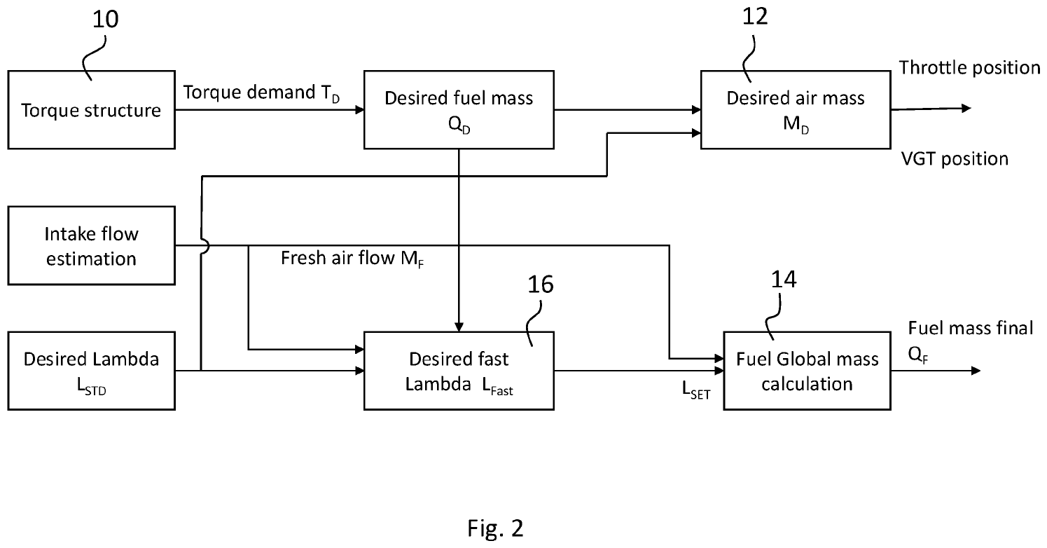

FIG. 2 illustrates an embodiment of the inventive method. The method is built on the conventional air-lead management scheme illustrated in FIG. 1, generally used with gasoline engines.

The method is designed to address transients due to a change in torque, and thus comes into play temporarily during such situation.

As explained above, under standard operation the scheme of FIG. 1 may be employed to run the hydrogen engine. L_{STD} is typically a value corresponding to a lean air/fuel ratio, for example L_{STD} may be in the range of 3 to 2.5, in particular around 2.7.

The present invention applies a strategy where a different lambda setpoint is used in case of a change in torque demand. Roughly speaking, L_{STD} values are calibrated to be applied during steady state engine conditions, where no increase or decrease of torque occurs. In such case the difference in torque demand (T_{D}) is considered to be rather low, including zero or quasi zero.

By contrast, the where the driver presses the pedal, or in case of deceleration (i.e. where the engine is no longer in steady state operation), there is difference (variation) in torque demand in the sense of the present method.

A variation in torque demand can generally be determined by comparing the current torque demand (e.g. T_{D}) to a previous reference value of torque demand.

In case a variation in torque demand is present, then a different lambda referred to as L_{FAST} is used as setpoint L_{SET} for the fuel global mass calculation 14.

The comparison can e.g. be done by subtraction or by computing a ratio, the result of which can then either be compared to a threshold or directly used as input in a map to influence the value L_{FAST} (as will be explained below). In embodiments, the current torque demand is compared to a moving average of torque demand (for previous combustion cycles).

L_{FAST} is the output value of module 16, which receives as input the current/actual air flow rate M_{F} and the standard lambda value L_{STD}.

First, a so-called raw lambda Lraw is computed based on the desired fuel mass Q_{D} and on the actual air flow rate M_{F}. Preferably Lraw is computed as:

$${L}_{raw} = \frac{{M}_{F}}{{Q}_{D} \cdot {AFR}_{stoichH 2}}$$

where AFR_{stoichH2} is the mass stoichiometric ratio of fuel to hydrogen: 34.33:1

Then Lraw is processed to introduce two limitations:
i) Lraw is capped to a maximum deviation with respect to the standard lambda value.

Here the value Lraw is compared to a value corresponding to a predetermined deviation ratio R_{DEV} with respect to L_{STD}, which is used as maximum deviation ratio. If Lraw exceeds the maximum value of the predetermined deviation ratio R_{DEV} applied to L_{STD}, then Lraw is bound (limited) to the max value.

For example, suppose that R_{DEV} is set to 15%. Then, in case of acceleration, the maximum allowable value for Lraw is 0.85×L_{STD}. Then, in case of deceleration, the maximum allowable value for Lraw is 1.15×L_{STD}.

The predetermined deviation ratio R_{DEV} is conveniently dependent on the difference in torque demand.

Hence in practice, R_{DEV} can be mapped in function of the difference in torque demand. It is thus possible to vary R_{DEV} with the amplitude of difference in torque demand. Furthermore, it is therewith possible, to set R_{DEV} to zero to forbid variations from LSTD, where the difference in torque demand is zero or very small. Hence in fact L_{FAST} may be computed all the time but configured such that it cannot vary from LSTD where the difference in torque demand reflects steady state operation.
ii) Lraw is then further capped between minimum and maximum values that are calibrated in function of engine speed and load.

Here the idea is to define a table having:
A maximum limit Lmax to avoid too “lean” combustion in order to keep acceptable combustion stability;
A lower limit Lmin to avoid too rich combustion to control Nox emissions and abnormal combustions;
   where Lmax and Lmin depend on engine speed and load.

Hence if Lraw is within the range [Lmin; Lmax] then the value Lraw is used as fast lambda value, i.e. as setpoint. This can be written as L_{FAST}=Lraw.

If Lraw exceeds Lmax, then L_{FAST} takes the value Lmax (L_{FAST}=Lmax)

If Lraw is below Lmin, then L_{FAST} takes the value Lmin (L_{FAST}=Lmin)

The so determined value L_{FAST} in module 16 is then forwarded to module 14, where it is used as lambda set value (L_{SET}=L_{FAST}).

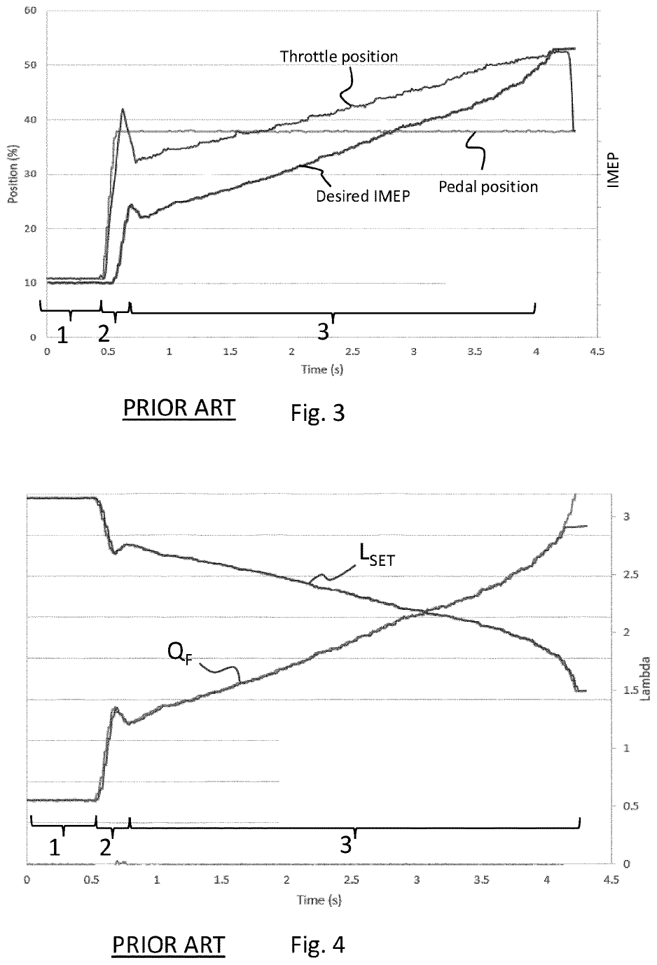

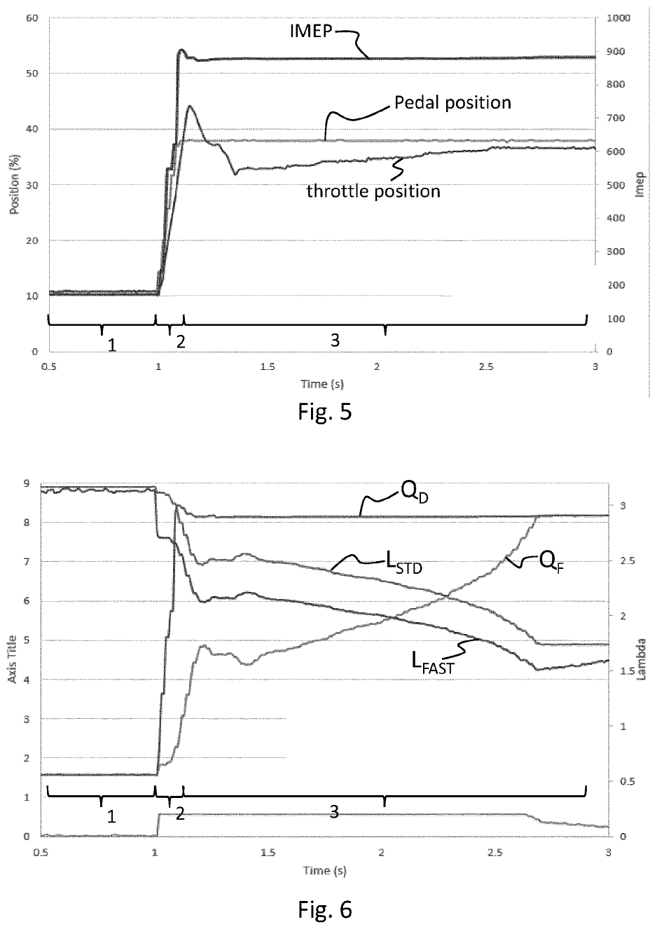

The effects of the present invention are illustrated by the plots of FIGS. 3-6, where FIGS. 3 and 4 correspond to conventional approach according to the diagram of FIG. 1. FIGS. 5 and 6 relate to the implementation of the present method.

The plots of FIGS. 3 and 5 both show, in function of time, the torque demand reflected by the accelerator pedal position (here a load step), the throttle position and the desired IMEP. The desired IMEP reflects the torque demand T_{D}.

FIGS. 4 and 6 illustrate corresponding variations of a number of combustion related parameters: fuel demand Q_{D}, fuel quantity Q_{F}, L_{SET}, and for FIG. 6 only the fast lambda L_{FAST} and relative ratio.

Referring to FIGS. 3 and 4, region 1 corresponds to steady state operating conditions, where it is useful to run as lean as possible to keep low Nox emission and reduce pumping torque when possible.

In the graph, one can see in section 2 that the torque increases quickly with throttle opening. In section 3, the torque increases slowly as lambda setpoint decrease.

It can be observed that the conventional approach brings a very long load transient because the lambda setpoint depends on the actual IMEP. This lag is due to a combination of elements: boost lag from the turbocharger running with low enthalpy (lean lambda setpoint); lambda demand depends on actual torque to get consistent combustion setpoints (Air/spark/injection timing demand).

In the example, the time period to achieve the target 900 kPa IMEP is 3.5 s. This is not considered acceptable.

Turning to FIGS. 5 and 6, a similar load step is again requested with a desired IMEP of 900 kP as load step.

As can be seen, torque increases quickly with throttle opening. The lambda setpoint L_{SET} is richer (15%) than standard lambda setpoint L_{STD}. It is resulting in +15% injected fuel quantity versus the scheme of FIGS. 3 and 4. The torque increases as the lambda setpoint decreases.

The time required to achieve 900 kPa IMEP is here 1.7 s.

Accordingly, the inventive method has the following benefits:
faster load transient is achievable by using an approach with combustion lambda authority;
there is no need to decrease spark efficiency when the driver torque is decreasing, which is favorable in terms of fuel economy.

1. A method of operating a hydrogen internal combustion engine, wherein combustion events are operated by injecting a predetermined fuel quantity Q_{F} in at least one cylinder, said method comprising the steps of:
determining a fuel demand Q_{D} from an input torque demand T_{D};
determining a corresponding desired air mass M_{D} based on said fuel demand Q_{D} and on a standard lambda number L_{STD}, and adjusting at least one charge air parameter based on said desired air mass M_{D}; and
determining the predetermined fuel quantity Q_{F} based on current (intake) air flow M_{F} rate and on a lambda setpoint L_{SET} corresponding to the standard lambda number L_{STD};
wherein in case of a variation in torque demand, the lambda setpoint L_{SET} is set to a lambda value referred to as fast lambda L_{FAST}, and
L_{FAST} is a lambda number computed based on the current air flow rate M_{F} and current fuel demand Q_{D}.

2. The method according to claim 1, wherein L_{FAST} is capped by a limit representing a relative lambda ratio R_{DEV} of L_{FAST} with respect to the standard lambda value L_{STD}.

3. The method according to claim 2, wherein said relative lambda ratio R_{DEV} is calibrated and dependent on the difference in torque demand.

4. The method according to claim 2, wherein said relative lambda ratio R_{DEV} lies between −30% and +30%.

5. The method according to claim 1, wherein fast lambda L_{FAST} is further capped between a minimum lambda value Lₘᵢₙ and a maximum lambda value Lₘₐₓ that are calibrated in function of engine speed and engine load.

6. The method according to claim 5, wherein
Lₘᵢₙ is in the range of about 1.5 to 1.8; and
Lₘₐₓ lies in the range of about 2.2 to 3.5.

7. The method according to claim 1, wherein said fuel demand Q_{D}, respectively said fuel quantity Q_{F}, are determined for an engine cycle.

8. The method according to claim 1, wherein said lambda setpoint L_{SET} is set back to standard lambda value when said difference in torque demand is low.

9. The method according to claim 1, wherein said variation in torque demand is determined based on a rate of change of torque demand.
